(19) United States
(12) Patent Application Publication
(10) Pub. No.: US 2014/0303837 A1
(43) Pub. Date: Oct. 9, 2014

(54) METHOD AND APPARATUS FOR AUTHORIZING ACCESS AND UTILIZATION OF A VEHICLE

(71) Applicant: NAVTEQ, Veldhoven (NL)

(72) Inventor: Marko Tapio Tuukkanen, Schlenzer (DE)

(73) Assignee: NAVTEQ, Veldhoven (NL)

(21) Appl. No.: 13/859,248

(22) Filed: Apr. 9, 2013

(51) Int. Cl. B60R 16/023; H04L 29/06

(52) U.S. Cl. CPC B60R 16/0231; H04L 63/0823
USPC 701/36

(57) ABSTRACT

An approach is provided for authorizing various access and utilization options at a vehicle via certificates. A device may process and/or facilitate a processing of one or more configuration parameters for determining one or more rights associated with a vehicle, wherein the rights include, at least in part, one or more access rights, one or more action rights, or a combination thereof. Further, the device may cause, at least in part, an association of the one or more rights with at least one certificate. Additionally, the device may cause, at least in part, a transfer of the at least one certificate to one or more service vendors, one or more users, or a combination thereof.

### BACKGROUND

Service providers are continually challenged to deliver value and convenience to consumers by providing compelling network services and advancing the underlying technologies. One area of interest has been developments in integrated vehicle control systems where users may access a variety of functionalities associated with a vehicle. Traditionally, an owner of a vehicle may temporarily provide a key to another user for accessing and utilizing the vehicle where the other user may have access to all options and features of the vehicle. For example, an owner of a vehicle may lend the vehicle to a family member or a friend, or may leave the vehicle at a service vendor location so that the vehicle may be serviced. In one instance, a user may park the vehicle at a parking facility where a user may wish or have to temporarily leave a key to the vehicle with a parking attendant. However, when the owner of the vehicle gives the keys of the vehicle to other users who may wish or need to access the vehicle, they may have full access to all options and areas of the vehicle for using or moving the vehicle as they wish, which may be different than what the owner of the vehicle had wished or agreed to.

### Some Example Embodiments

Therefore, there is a need for an approach for authorizing various access and utilization options at a vehicle via certificates.

According to one embodiment, a method comprises processing and/or facilitating a processing of one or more configuration parameters for determining one or more rights associated with a vehicle, wherein the rights include, at least in part, one or more access rights, one or more action rights, or a combination thereof. The method also comprises causing, at least in part, an association of the one or more rights with at least one certificate. The method further comprises causing, at least in part, a transfer of the at least one certificate to one or more service vendors, one or more users, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of one or more configuration parameters for determining one or more rights associated with a vehicle, wherein the rights include, at least in part, one or more access rights, one or more action rights, or a combination thereof. The apparatus is also caused to cause, at least in part, an association of the one or more rights with at least one certificate. The apparatus is further caused to cause, at least in part, a transfer of the at least one certificate to one or more service vendors, one or more users, or a combination thereof.

According to another embodiment, a computer-readable storage medium carries one or more sequences of one or more instructions which, when executed by one or more processors, cause, at least in part, an apparatus to process and/or facilitate a processing of one or more configuration parameters for determining one or more rights associated with a vehicle, wherein the rights include, at least in part, one or more access rights, one or more action rights, or a combination thereof. The apparatus is also caused to cause, at least in part, an association of the one or more rights with at least one certificate. The apparatus is further caused to cause, at least in part, a transfer of the at least one certificate to one or more service vendors, one or more users, or a combination thereof.

According to another embodiment, an apparatus comprises means for comprises processing and/or facilitating a processing of one or more configuration parameters for determining one or more rights associated with a vehicle, wherein the rights include, at least in part, one or more access rights, one or more action rights, or a combination thereof. The apparatus also comprises means for causing, at least in part, an association of the one or more rights with at least one certificate. The apparatus further comprises means for causing, at least in part, a transfer of the at least one certificate to one or more service vendors, one or more users, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of authorizing various access and utilization options at a vehicle via certificates, according to an embodiment;

FIG. 2 is a diagram of the components of a vehicle interface client, according to an embodiment;

FIG. 3 is a diagram of the components of a user equipment capable of authorizing various access and utilization options at a vehicle via certificates, according to an embodiment;

FIGS. 4 through 6 illustrate flowcharts of various processes for, at least, authorizing various access and utilization options at a vehicle via certificates, according to various embodiments;

FIG. 7 illustrates an example use case scenario flow chart, according to various embodiments;

FIGS. 8A through 8D illustrate various user interface diagrams for interfacing with a vehicle interaction client, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for authorizing various access and utilization options at a vehicle via certificates and/or virtual keys. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to authorizing rights for accessing and utilizing a vehicle, it is contemplated that the approach described herein may be used with various remote, local, and/or virtual devices. Further, the authorization may be via applications and devices in communication via short range, point-to-point connection, virtual interfacing, ad-hoc networking, and the like.

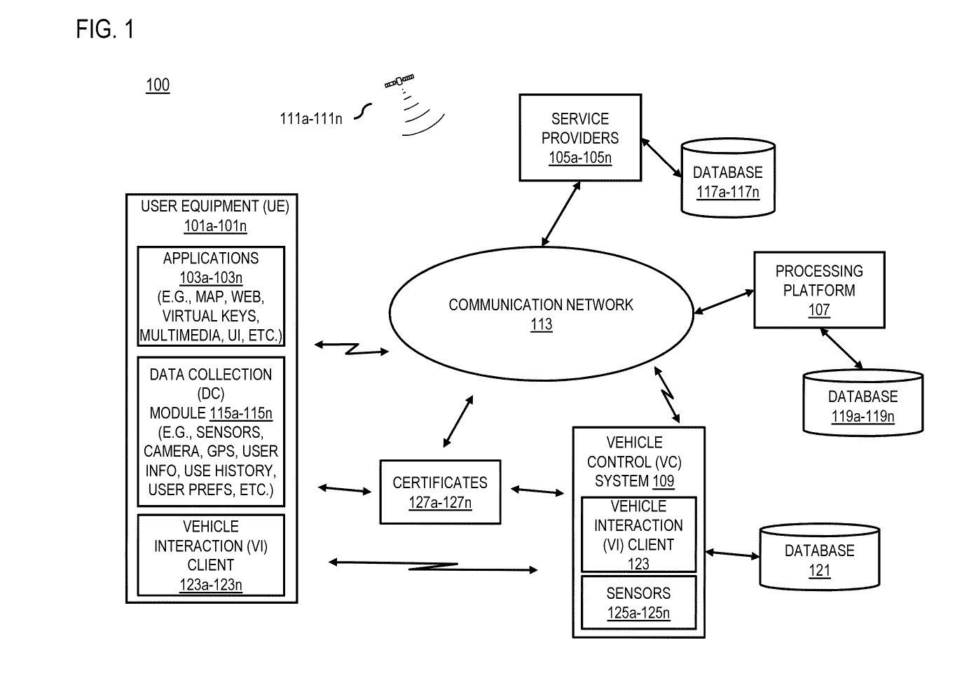

FIG. 1 is a diagram of a system capable of authorizing various access and utilization options at a vehicle via certificates and/or virtual keys. As discussed above, an owner of a vehicle; for example, a car, a boat, a plane, a motorbike, etc., may wish to allow other users to access or utilize the vehicle at different times, different locations, and for different reasons. For example, an owner may wish to lend his vehicle to a temporary user (e.g., a family member, a friend, etc.) where the owner may give a key to the vehicle to the temporary user. In another example, the owner may wish to leave the vehicle at a parking facility or at a service vendor facility where he may wish or need to leave the keys to the vehicle with a potential temporary user, which may require an in-person meeting with the temporary user or leaving the keys at a predefined location. However, the owner may wish to restrict use and access to the vehicle based on who the temporary user may be, a location of the vehicle, a reason for the access/use, a duration of time, etc. In another scenario, a temporary user may need to access/use the vehicle which may not be in accordance with an agreement with the owner of the vehicle. In one instance, a parking facility attendant may need to move the vehicle within the parking facility after the owner of the vehicle has parked the vehicle at a particular parking space, for example, so that the vehicle may be washed at a different location within the parking facility or at a different nearby location. In another instance, the vehicle may need to be moved within the service vendor facilities in order to avoid damages due to an emergency at the facilities (e.g., fire, flooding, construction debris, etc.) Although some modern vehicles can interface with wireless keys, an owner of such vehicle still would need to temporarily give a wireless key to another user when giving the responsibility (e.g., lending, parking, etc.) of the vehicle to the other user without any controls over the access and utilization of the vehicle.

To address, at least these problems, a system 100 of FIG. 1 introduces the capability for authorizing various access and utilization options at a vehicle via certificates and/or virtual keys. In the following discussions, certificates and virtual keys may be interchangeably referred to in various examples and embodiments. As vehicle control systems have advanced to include various sensors and applications for access, security, safety, performance, etc., a user or an owner of a vehicle may interact with the control system for configuring a broad range of options and settings associated with the vehicle's access control, entrainment system, navigation system, performance options, and the like, wherein the options and the settings may be customized for a plurality of users who may have or may need to have access to the vehicle. In various embodiments, a vehicle owner may utilize an application program at the vehicle, on a user device (e.g., a mobile phone), or via a service provider e.g., cloud service) to create one or more access authorizations/rights to the vehicle, associate the access rights with one or more certificates, and then provide/transfer the certificates to one or more users and/or service vendors. In various embodiments, a vehicle owner and a service vendor (e.g., a parking facility, a repair shop, a tire shop, a car wash facility, etc.) may already be in possession of various trusted certificates, generated by an authorized service provider, where the owner may, authorize the service provider to associate various access rights with the service vendor certificate without an exchange of a certificate.

In one use case scenario, an owner of a vehicle may be on travel and parks his vehicle at a parking facility where he may transfer a certificate to a service vendor so that the service vendor may service the car, move the car, notify the owner of any issues related to the vehicle or the services, and the like, wherein the certificate may be transferred to one or more user devices (e.g., a mobile phone, a kiosk, a memory tag, etc.) associated with the service vendor.

In one use case scenario, an owner of a vehicle may agree to lend his vehicle to a family member (or a friend) where he may transfer a certificate to the family member via a user device associated with the family member.

In various use case scenarios, an owner of a vehicle (or an authorized user/representative) may create a plurality of certificates and associate various options, restrictions, functionalities, and the like with each certificate. In one use case scenario, a service provider authorized to manage certificates may create certificates for vehicle owners, service vendors for authorizing a service vendor on behalf of the vehicle owner without an exchange of a certificate between the owner and the service vendor.

In one scenario, a vehicle master user (e.g., an owner) may grant various rights to a family member where the family member may have rights to authorize one or more rights, for example, to a service vendor with a subset of the family member's rights. In one example, a first temporary user (e.g., a family member) may transfer one or more rights to another temporary user (e.g., a friend) where the transferred rights may cause suspension/cancellation of those rights in the first temporary user's certificate. Further, any transfer and/or forwarding of rights from one temporary user to another temporary user may cause one or more notifications to one or more owners, master users, service providers, and the like. In one embodiment, the VC system 109 may cause a transfer of one or more rights to a temporary user (e.g., a service vendor, an authorized user, etc.) if the VC system 109 detects (e.g., via the sensors 125) one or more urgent/emergency events (e.g. a nearby fire, unusually high temperature, etc.) so that the temporary user may assist with the urgent/emergency event.

As shown in FIG. 1, in one embodiment, the system 100 includes user equipment (UE) 101a-101n (also collectively referred to as a UE 101 and/or UEs 101), which may be utilized to execute one or more applications 103a-103n (also collectively referred to as applications 103) including navigation application, security applications, virtual keys, games, social networking, web browser, media application, user interface (UI), map application, web client, etc. to communicate with other UEs 101, one or more service providers 105a-105n (also collectively referred to as service provider/providers 105), a processing platform 107, a vehicle control (VC) system 109, one or more satellites 111a-111n (also collectively referred to as the satellite system 111), and/or with other components of a the system 100 directly and/or over a communication network 113. In one embodiment, the UEs 101 may include data collection modules 115a-115n (also collectively referred to as DC module 115) for determining and/or collecting data associated with the UEs 101, one or more sensors of the UE 101, one or more users of the UEs 101, applications 103, one or more content items, and the like. In one embodiment, the UEs 101 may include one or more vehicle interaction clients 123a-123n (also collectively referred to as VI client 123), which will be discussed below.

In one embodiment, the service providers 105 may include and/or have access to one or more databases 117a-117n (also collectively referred to as database 117), which may include various mapping data, user information, user profiles, user preferences, one or more profiles of one or more user devices (e.g., device configuration, sensors information, etc.), information on the service providers 105, and the like. In one embodiment, the service providers 105 may include one or more service providers offering one or more services, for example, location based services, online shopping, social networking services (e.g., blogging), content sharing, media upload, media download, media streaming, account management services, or a combination thereof. Further, the service providers 105 may conduct a search for content items, media items, information, product and/or service information, and the like associated with one or more users, content items, POIs, geo-locations, and the like.

In one embodiment, the processing platform 107 may include and/or have access to one or more database 119a-119n (also collectively referred to as database 119), which may store, include, and/or have access to various data, for example, from different sources and/or different time periods, user information, user profiles, certificates, authorization codes, vehicle configuration information, device information, contents, service provider information, service vendor information, and the like. In one embodiment, one or more portions of the processing platform 107 may be implemented in a UE 101, at a computer, at a server, and the like. In various embodiments, the processing platform 107 may be configured to operate partially or completely as a stand-alone entity or as part of a service provider 105. In one embodiment, the processing platform 107 may utilize various programs or algorithms for processing and analyzing various authentication, authorization, security, and the like parameters associated with a user, a user device, a vehicle, and the like. By way of example, the processing platform 107 may be operable for direct execution by a device, i.e., a UE 101. Under this approach, the processing platform 107 may be implemented as a software executable, hardware executable, or a combination thereof. Alternatively, the processing platform 107 may be accessed via a communication network 113 as a service or a platform. In either implementation, the processing platform 107 is configured to, at least, facilitate processing and analysis of authorization or authentication requests associated with a user, a user device, a vehicle, and the like. In various embodiments, the processing platform 107 may be maintained on a network server and include a web-service, an applet, a script, an object-oriented application, and the like while operating in connection with one or more sensors and/or devices in a user environment. In one embodiment, the processing platform 107 may process contextual information associated with data presented at a device, wherein one or more commands, authorizations, authentications, rights, and the like may be determined from the contextual information.

In one embodiment, the VC system 109 may include various mechanisms for detecting, capturing, and processing data associated with a vehicle and/or a user. For example, the VC system 109 may process various user and vehicle data for controlling various functions of the vehicle. In one embodiment, the VC system 109 may include a VI client 123 for facilitating an interface between a vehicle, a user, a user device, or a combination thereof. For example, the VI client 123 may present a user interface (UI) to a user for detecting one or more user inputs. In various embodiments, the VI client 123 may determine one or more executable commands based on one or more user inputs, wherein the commands may be associated with determining and transferring various authorization keys/codes, authentication codes, rights management data, and the like, between a vehicle and a plurality of devices. In various embodiment, the VC system 109 may be implemented in an integrated in-vehicle system including, for example, one or more mobile devices (e.g., a mobile phone, a tablet, etc.) In one embodiment, the VC system 109 may include and/or interface with sensors 125a-125n (also collectively referred to as sensors 125) for detecting and analyzing data associated with a vehicle, for example, location sensors, speedometer, cameras, microphones, Bluetooth®, WLAN, near field communications (NFC), radio frequency identification (RFID), infrared (IR), and the like. In one embodiment, the sensors 125 may be partially or completely integrated with the VC system 109 or the sensors 125 may be implemented as one or more modules. In various embodiments, the UEs 101 and the sensors 125 may include a combination of various sensors, for example, one or more wearable sensors, accelerometers, physiological sensors, biometric sensors, location sensors, and the like. By way of example, connectivity between the UEs 101, the VC system 109, and the sensors 125 may be facilitated by short range wireless communications (e.g., Bluetooth®, WLAN, ANT/ANT+, ZigBee, etc.) Furthermore, the VC system 109 may include or may have access to database 121, wherein various vehicle and user data may be stored. In various embodiments, the VC system 109 and/or the database 121 may be partially or completely implemented within one or more devices, one or more modules, one or more architectures, and the like.

In one embodiment, the system 100 may utilize certificates 127a-127n (also collectively referred to as certificate/certificates 127), which may be digital files, notes, messages, authorization codes, access/utilization rights, and the like associated with various rights and authorizations that may be transferred among the UEs 101, a service provider 105, a processing platform 107, a VC system 109, a service vendor, and/or other elements of the system 100 directly and/or via the communication network 113.

In one embodiment, the system 100 processes and/or facilitates a processing of one or more configuration parameters for determining one or more rights associated with a vehicle, wherein the rights include, at least in part, one or more access rights, one or more action rights, or a combination thereof. In one embodiment, a VI client 123; for example at a UE 101, at a VC system 109, and the like, may receive input from a user that may include various configuration parameters for defining various options and features at the vehicle. For example, the options and features may include one or more rights for accessing the vehicle and/or perform various actions available at the vehicle. In one instance, the rights may include an authorization for one or more users to access a vehicle, start its engine, move the vehicle, utilize a communication device of the vehicle, and the like. In one embodiment, the rights may include one or more authorization for a service vendor to provide and/or facilitate one or more services on the vehicle. For example, the rights may indicate that a service vendor may wash the vehicle as well as rotate its tires. In one embodiment, the rights may indicate that a service vendor may charge any fees to a user account, wherein the charges may be associated with one or more requested services and/or for utilization of the service vendor facilities.

In one embodiment, the system 100 causes, at least in part, an association of the one or more rights with at least one certificate. In one embodiment, the VI client 123 may utilize one or more algorithms, applications, software programs, and the like to associate the one or more rights with one or more certificates where the certificates may include authorization codes/keys, authentication codes/keys, security codes, and the like. In various examples, the certificates may include encoded alphanumeric characters, a passphrase, etc. In one example, a parking service vendor may have promised to service a vehicle, but the service may not be able to be completed that the parking facilities as previously planned. Later, the owner of the vehicle may not have data connection with the vehicle; however, the service vendor may call the vehicle owner to request an authorization code or a passphrase to utilize via a network service provider, a dedicated application, at the VC system 109, etc. so that the current set of rights may be amended to provide the rights so that the service vendor may complete the promised service at a different service facility.

In one embodiment, the system 100 causes, at least in part, a transfer of the at least one certificate to one or more service vendors, one or more users, or a combination thereof. In one embodiment, a VI client 123 may transfer or authorization of a certificate to a user device; for example, to a UE 101, where a user and/or a service vendor may utilize the user device for accessing a specific vehicle. In one embodiment, the processing platform 107 and/or a service provider 105 may cause the transfer of a certificate. In one embodiment, a certificate may include one or more rights associated with a plurality of vehicles. In one example, a user may be a temporary user, for instance, a friend, a family member, a service attendant, and the like. In one example, a service vendor may include one or more purveyors of vehicle services, for instance, at a parking garage, at a repair facility, at a marina, at an airport, and the like.

In one embodiment, the system 100 determines the one or more configuration parameters based, at least in part, on a location of the vehicle, a duration of time, identity of the one or more users, one or more inputs by a master user of the vehicle, or a combination thereof. In various embodiments, a master user (e.g., an owner) may define the configuration parameters to include various elements for defining validity of the rights according to, for example, a location of the vehicle, a time of day, day of week, for a specific duration of time, identity of the user who may utilize the rights, and the like. In one embodiment, the at least one certificate provides access to a physical space at the vehicle, a vehicle movement, one or more options at the vehicle, or a combination thereof. For example, a user may be authorized to access and utilize a vehicle during the hours of 8:00 AM and 2:00 PM, within a particular geo-graphic location, without access right to the in-vehicle mobile phone or glove compartment, while the vehicle may not exceed a speed of 50 miles-per-hour (mph), and the like.

In one embodiment, the system 100 causes, at least in part, an enabling, a disabling, or a combination thereof of the one or more options at the vehicle based, at least in part, on the at least one certificate. In one embodiment, the VC system 109 may enable or disable one or more options and features at a vehicle. For example, a certificate may be associated with one or more rights that may cause the VC system 109 to disable a feature to raise the top on a convertible vehicle, or disable a sports-mode driving option, or disable one or more functions of an infotainment system in the vehicle, and the like.

In one embodiment, the system 100 processes and/or facilitates a processing of one or more requests from the vehicle, the one or more users, the one or more service vendors, or a combination thereof for modifying the one or more rights. In one embodiment, a temporary user may request to have the rights associated with his certificate modified so that he may be able to utilize one or more options and features differently than what may have been associated with his certificate. For example, the temporary user may need to move the vehicle from its current location to a different location (e.g., to avoid damage due to a nearby fire) or may wish to move it outside of the geo-location boundary (e.g., a teenager wishes to drive to a friend's house outside of a predefined geo-location boundary) associated with his certificate. In various examples, a certificate may include one or more rights to allow for a temporary user to drive the vehicle for a certain duration of time (e.g., two hours from initial use), for a certain total distance (e.g., 20 miles), along a certain route (e.g., from a point A to a point B), and the like.

In one embodiment, the system 100 causes, at least in part, a presentation of one or more requests to the master user. In one embodiment, the VC system 109 and/or UE 101 may cause a request message to be sent to a master user of the vehicle who may be at a remote location from the vehicle. In one embodiment, the request may be presented via one or more service providers associated with the temporary user, with the master user, with a service vendor facility, and the like.

In one embodiment, the system 100 causes, at least in part, an updating of the one or more rights based, at least in part, on an input by the master user. In various embodiments, the processing platform 107, a service provider 105, and/or another component in the system 100 may determine an input by the master user for updating the one or more rights according to the master user input. For example, the master user may agree with changing the rights associated with a certificate of an attendant at a parking facility so that the attendant may move the vehicle to a different parking space. In one example, a service vendor may need to move the vehicle to another service vendor facility for additional services.

In one embodiment, the system 100 causes, at least in part, a transmission of one or more status notifications associated with the vehicle to the one or more users, the master user, the one or more service vendors, or a combination thereof based, at least in part, on data from one or more sensors at the vehicle. In one embodiment, a VC system 109, a VI client 123, and/or one or more other components of the system 100 may cause for status information from one or more sensors of the vehicle to be sent to a master user. For example, a VC system 109 may determine that a tire pressure sensor on the vehicle indicates that the associated tire may need servicing. In one example, a location sensor of a vehicle may indicate that location of the vehicle is changing and may be outside the geo-location boundaries set by the master user.

In one embodiment, the system 100 determines whether the one or more status notifications include one or more urgent events associated with the one or more sensors. In various embodiments, various sensors of a vehicle may detect an event (e.g., a potential emergency) at or near the vehicle, which may need urgent attendance by a person or a service vendor. For example, a heat sensor on the vehicle may detect heat from the surrounding area, which can indicate that a nearby vehicle or structure may be malfunctioning, may be on fire, and the like.

In one embodiment, the system 100 causes, at least in part, the updating based at least in part, on the one or more urgent events, the input by the master user, or a combination thereof. In one embodiment, the master user may cause the processing platform 107 and/or a service provider 105 to transfer rights to one or more temporary users and/or service vendors via one or more certificates for addressing the one or more urgent events. In one example, the service provider 105 may receive an input from the master user for updating (e.g., approving) one or more rights for a service vendor to disconnect a malfunctioning alarm on the vehicle.

In one embodiment, the system 100 determines one or more functional limitations based, at least in part, on the at least one certificate. In one example, a certificate may be configured to indicate one or more functional limitations at a vehicle. For example, a certificate may not allow a user to open various compartments at a vehicle. In one example, a temporary user may not able to utilize the certificate more than a certain number of uses. In one example, the temporary user may not be able to open the trunk or rear doors of a vehicle. In one instance, a certificate may not include rights for a temporary user to use all features of an in-vehicle infotainment system, for example, to buy/rent content (e.g., music, navigation maps, concierge services, etc.) using the vehicle owner's credentials previously saved in the in-vehicle infotainment system. In one example, a certificate may not allow a temporary user to modify settings of an in-vehicle infotainment system, e.g., change preset radio channels, add new radio channels, and the like. In one embodiment, a certificate may cause a VC system 109 to request that a temporary user would have to provide a breath sample (e.g., blow in to an breath analyzer to detect alcohol, other substances, etc.) for activating one or more rights and/or certificates associated with the vehicle. In one example, a temporary user may only drive the vehicle between the hours of 8:00 AM and 8:00 PM, but on Friday nights, the temporary use may have to provide the breath sample before the certificate and/or any rights are enabled for using the vehicle.

In one embodiment, the system 100 causes, at least in part, an associating the one or more functional limitations with the one or more sensors. In various examples, a certificate may cause one or more sensors of a vehicle to function under certain limitations, for instance, a camera and a microphone of an entertainment system may be disabled. In one example, an accelerator at the vehicle may be allowed to only function to a certain preset level.

In one embodiment, the system 100 causes, at least in part, a storing of the one or more rights at the vehicle, at one or more devices, at the one or more service vendors, or a combination thereof. In various embodiments, various data associated with the rights and various users, devices, keys, and the like may be stored at one or more UEs 101, the certificates 127, a service provider database 117, a local storage 121 at the vehicle, and the like. In various embodiments, a master user, a VC system 109, a service provider 105, and the like may access the stored information for future use associated with the vehicle, one or more rights, one or more temporary users, and the like.

In one embodiment, the system 100 processes and/or facilitates a processing of at least one invalidating request from the master user for invalidating the at least one certificate. In one example, a master user may wish to cancel one or more portions of one or more rights associated with one or more certificates, which may be associated with a vehicle, one or more temporary users, and the like. For example, a master user (e.g., an owner) may wish to cancel the rights associated with a certificate and a temporary user so that the one or more rights may be assigned to one or more other temporary users. In one example, a master user may have a scheduling conflict associated with one or more certificates already assigned to one or more temporary users.

In one embodiment, the system 100 causes, at least in part, an invalidating of the at least one certificate based, at least in part, on the at least one invalidating request. In one example, the processing platform 107, the service provider 105, and/or a UE 101 may cause invalidating of the one or more certificates, for instance, by transmitting one or more commands/messages to the UEs 101 and/or to the VC system 109.

In various embodiments, the UE 101, the VC system 109 and/or the UEs 101 may include one or more location modules/sensors that can determine the UE 101, the VC system 109 and/or the UEs 101 location (e.g., a user/vehicle indoor/outdoor location). The location information can be determined by a triangulation system such as a GPS, assisted GPS (A-GPS), Cell of Origin, wireless local area network triangulation, or other location extrapolation technologies. Standard GPS and A-GPS systems can use the one or more satellites 111 to pinpoint the location (e.g., longitude, latitude, and altitude) of the UE 101, the VC system 109 and/or the UEs 101. A Cell of Origin system can be used to determine the cellular tower that a cellular device (e.g., a UE 101) is synchronized with. This information provides a coarse location of the UE 101 because the cellular tower can have a unique cellular identifier (cell-ID) that can be geographically mapped. The location module/sensor may also utilize multiple technologies to detect the location of the UE 101, the VC system 109 and/or the UEs 101. GPS coordinates can provide finer detail as to the location of the UE 101. In another embodiment, the UE 101 may utilize a local area network (e.g., WLAN) connection to determine the UE 101 location information, for example, from an Internet source (e.g., a service provider). It is also contemplated that one or more AR, VR, and/or MR applications may be used to render a virtual presentation associated with one or more users.

Although various embodiments are discussed with respect to authorizing various access and utilization options at a vehicle via certificates, it is contemplated that embodiments of the approach described herein are applicable to user interaction with various devices for authorizing and controlling access rights of various types of devices.

By way of example, the communication network 113 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101 may be any type of mobile terminal, fixed terminal, or portable terminal including a mobile handset, station, unit, device, healthcare diagnostic and testing devices, product testing devices, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, TV receiver, radio broadcast receiver, electronic book device, game device, or any combination thereof, including the accessories and peripherals of these devices, or any combination thereof. It is also contemplated that the UEs can support any type of interface to the user (such as “wearable” circuitry, etc.). Further, the UEs 101 may include various sensors for collecting data associated with a vehicle, a user, a user's environment, and/or with a UE 101, for example, the sensors may determine and/or capture audio, video, images, atmospheric conditions, device location, user mood, ambient lighting, user physiological information, device movement speed and direction, and the like.

By way of example, the UEs 101, the VC system 109, the service provider 105, and the processing platform 107 may communicate with each other and the other components of the system 100 using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, one or more entities of the system 100 may interact according to a client-server model with the applications 103 and/or the DC module 115 of the UE 101. According to the client-server model, a client process sends a message including a request to a server process, and the server process responds by providing a service (e.g., context-based grouping, social networking, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

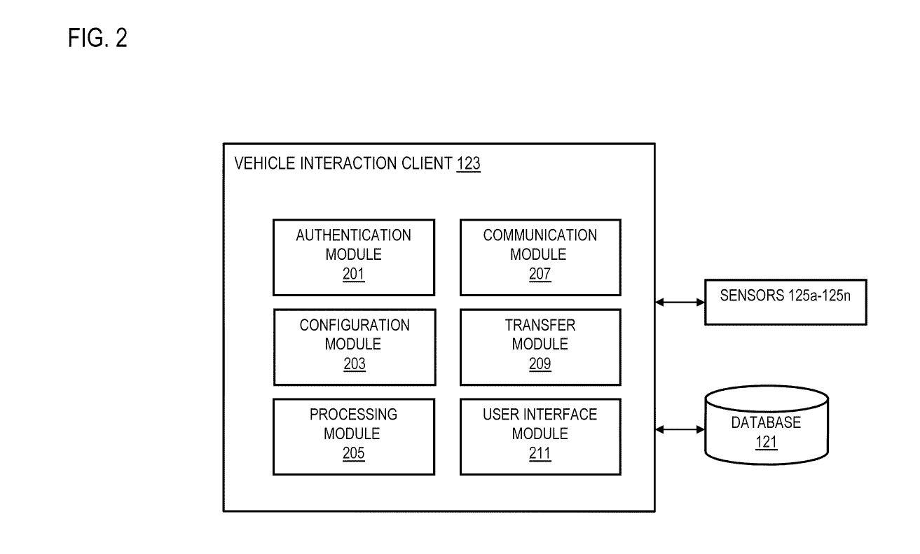

FIG. 2 is a diagram of the components of a vehicle interface client, according to an embodiment. By way of example, the VI client 123 includes one or more components for authorizing various access and utilization options at a vehicle via certificates. As previously noted, one or more portions of the VI client 123 may be implemented in a UE 101, for example, in an in-vehicle integrated system in a tablet, a mobile device, and the like. It is contemplated that the functions of these components may be combined in one or more components or performed by other components of equivalent functionality. In one embodiment, the VI client 123 includes an authentication module 201, a configuration module 203, a processing module 205, a communication module 207, a transfer module 209, and a user interface module 211.

In addition, the VI client 123 may be configured to maintain various profile data at the database 121 where profile data associated with one or more users and/or UEs 101 may be stored and utilized as well as configured to interact with the sensors 125.

In one embodiment, an authentication module 201 authenticates users and UEs 101 for interaction with one or more UEs 101, for example, a VC system 109, a processing platform 107, a service provider 105, and the like. In one embodiment, the authentication module 201 operates with the configuration module 203 to enable a user to define one or more configuration parameters for determining and/or modifying one or more rights associated with a vehicle, a UE 101, and the like. Further, the authentication module 201 may further operate in connection with the user interface module 211 for causing rendering of an interface for receiving user input for configuration of one or more rights, one or more certificates, and transferring of the certificates to one or more devices, one or more users, one or more service vendors, and the like. In addition, the authentication module 201 enables the establishing of various profile data for configuring various settings, tolerances, reactions, and preferences of the user and/or a UE 101. Preferences and settings information can be referenced to a specific user, user equipment, or combination thereof. The profile authentication module 201 and the profile data may also facilitate one or more rights and permissions for permitting access to a data source. In one embodiment, the authentication module 201 may receive and authenticate one or more certificates for granting access to a VC system 109 and/or a vehicle associated with the VC system 109.

In one embodiment, the configuration module 203 may configure one or more certificates via one or more algorithms, applications, software programs, and the like, wherein the certificates may be encoded to provide security when transferring and receiving the certificates to and from various other devices.

The processing module 205 is also configured to operate in connection with the authentication module 201 and the configuration module 203. The processing module 205 may process various data from a user, a UE 101, a service provider 105, the processing platform 107, the sensors 125, and the like. For example, the processing module 205 may process data from various sources and determine which module and/or component in the VI client 123 and/or the VC system 109 should further utilize the processed data.

In one embodiment, a communication module 207 enables communication among the UEs 101, the VC system 109, the service provider 105 and other components of the system 100 via one or more proximity-based communication channels (e.g., Bluetooth®, WLAN, etc.) and/or via a network based (e.g., cellular) session over the communication network 113. By way of example, the communication module 207 executes various protocols and data sharing techniques for enabling collaborative execution among the system 100 components via the communication network 113.

In one embodiment, the transfer module 209 facilitates transfer of the certificates to the UEs 101, the service provider 105, the processing platform 107, a dedicated device at a service vendor location (e.g., an RFID tag/device) or to other components of the system 100. In one embodiment, the transfer module works in connection with the communication module 207 for causing the transfer of the certificates.

In one embodiment, the user interface module 211 enables presentation of a graphical user interface for facilitating user input of various configuration parameters. By way of example, the user interface module 211 generates the interface in response to application programming interfaces (APIs) or other function calls corresponding to applications, data, parameters, commands, and the like associated with a UE 101, a VI client 123, a VC system 109, and/or other components of the system 100. In one embodiment, the UI 211 may utilize various UI technologies available on a UE 101 for interfacing with the user. For example, a touch sensitive display, a detection field (e.g., capacitive, electromagnetic, etc.), audio/video input, and the like. It is noted that the user interface module 211 may operate in accordance with various operating system environments for supporting the rendering of one or more representations of various information, content, data, and the like.

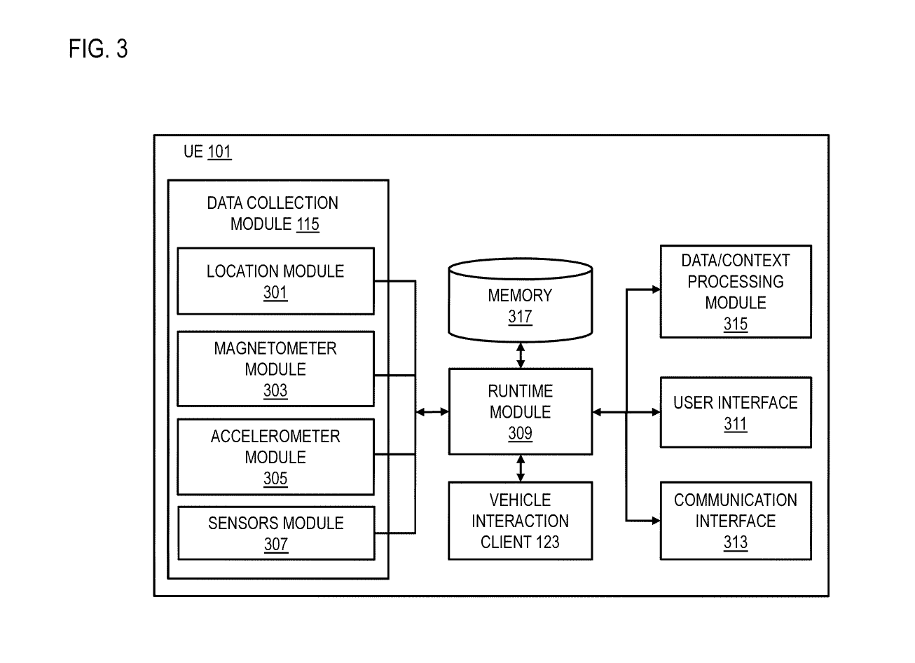

FIG. 3 is a diagram of the components of a user equipment capable of authorizing various access and utilization options at a vehicle via certificates, according to an embodiment. By way of example, a UE 101 includes one or more components for determining user input for authorizing various access and utilization options at a vehicle via certificates to effectuate establishing rights, associating the rights to certificates, and transferring of the certificates to various users. It is contemplated that the functions of these components may be combined in one or more components or performed by other components of equivalent functionality. In this embodiment, the UE 101 includes a data collection module 115 that may include one or more location modules 301, magnetometer modules 303, accelerometer modules 305, and sensors modules 307. Further, the UE 101 may also include a runtime module 309 to coordinate the use of other components of the UE 101, a user interface 311, a communication interface 313, a data/context processing module 315, a memory 317, and a vehicle interaction client 123. The applications 103 of the UE 101 can also execute on the runtime module 309 utilizing the components of the UE 101.

The location module 301 can determine a user's location, for example, via location of a UE 101. The user's location can be determined by a triangulation system such as GPS, assisted GPS (A-GPS), Cell of Origin, or other location extrapolation technologies. Standard GPS and A-GPS systems can use satellites 111 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 301 may also utilize multiple technologies to detect the location of the UE 101. Location coordinates (e.g., GPS coordinates) can give finer detail as to the location of the UE 101 when media is captured. In one embodiment, GPS coordinates are stored as context information in the memory 317 and are available to the processing platform 107, the service provider 105, and/or to other entities of the system 100 via the communication interface 313. Moreover, in certain embodiments, the GPS coordinates can include an altitude to provide a height. In other embodiments, the altitude can be determined using another type of altimeter. In certain embodiments, the location module 301 can be a means for determining a location of the UE 101, an image, or used to associate an object in view with a location.

The magnetometer module 303 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer can be stored in memory 317, made available to other modules and/or applications 103 of the UE 101, and/or transmitted via the communication interface 313 to one or more entities of the system 100.

The accelerometer module 305 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 305 can determine the angle the UE 101 is pointed as compared to Earth's gravity. In certain embodiments, the magnetometer module 303 and accelerometer module 305 can be means for ascertaining a perspective of a user. This perspective information may be stored in the memory 317, made available to other modules and/or applications 103 of the UE 101, and/or sent to one or more entities of the system 100.

In various embodiments, the sensors module 307 may include various sensors for detecting and/or capturing data associated with the user and/or the UE 101. For example, the sensors module 307 may include sensors for capturing environmental (e.g., atmospheric) conditions, audio, video, images, location information, temperature, user physiological data, user mood (e.g., hungry, angry, tired, etc.), user interactions with the UEs 101, and the like. In certain embodiments, information collected from and/or by the data collection module 115 can be retrieved by the runtime module 309, stored in memory 317, made available to other modules and/or applications 103 of the UE 101, and/or sent to one or more entities of the system 100.

The UI 311 can include various methods of communication. For example, the user interface 311 can have outputs including a visual component (e.g., a screen), an audio component, a physical component (e.g., vibrations), and other methods of communication. User interface can include a touch-screen interface, a detecting/sensitivity-field around one or more sides, a scroll-and-click interface, a button interface, a microphone, etc. Input can be via one or more methods such as voice input, textual input, typed input, typed touch-screen input, other touch-enabled input, etc.

In one embodiment, the communication interface 313 can be used to communicate with one or more entities of the system 100. Certain communications can be via methods such as an internet protocol, messaging (e.g., SMS, MMS, etc.), Bluetooth®, NFC, IR, or any other communication method directly among the UEs 101 and/or via the communication network 113. In some examples, the UE 101 can transfer contents associated with a UE 101 to one or more other UEs 101 and/or components of the system 100.

The data/context processing module 315 may be utilized in determining context information from the data collection module 115 and/or applications 103 executing on the runtime module 309. For example, it can determine user activity, content consumption, application and/or service utilization, user information, type of information included in the data, information that may be inferred from the data, and the like. The data may be shared with the applications 103, and/or caused to be transmitted, via the communication interface 313, to the service provider 105 and/or to other entities of the system 100. The data/context processing module 315 may additionally be utilized as a means for determining information related to the user, various data, the UEs 101, and the like. Further, data/context processing module 315, for instance, may manage (e.g., organizes) the collected data based on general characteristics, rules, logic, algorithms, instructions, etc. associated with the data. In certain embodiments, the data/context processing module 315 can infer higher level context information from the context data such as favorite contents, significant places, common activities, interests in products and services, etc.

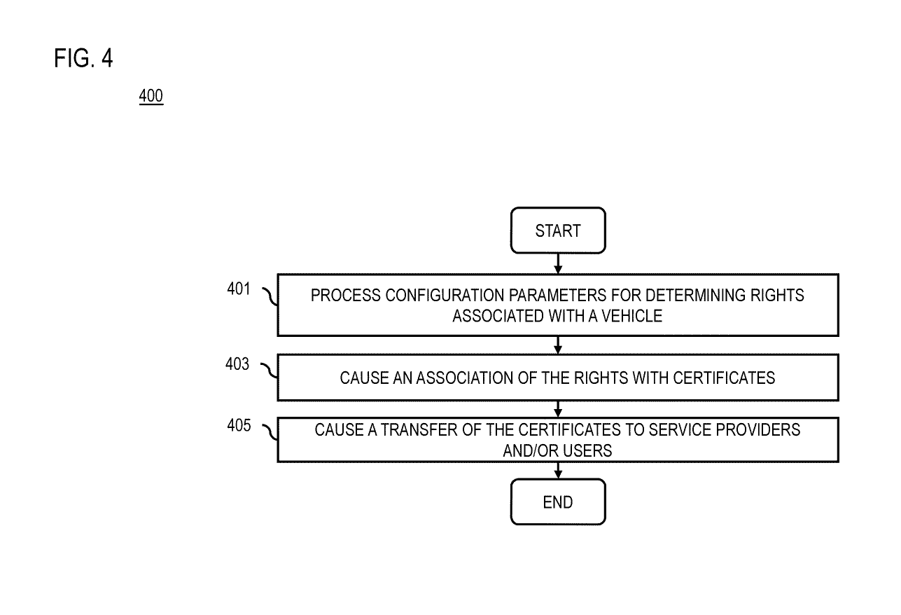

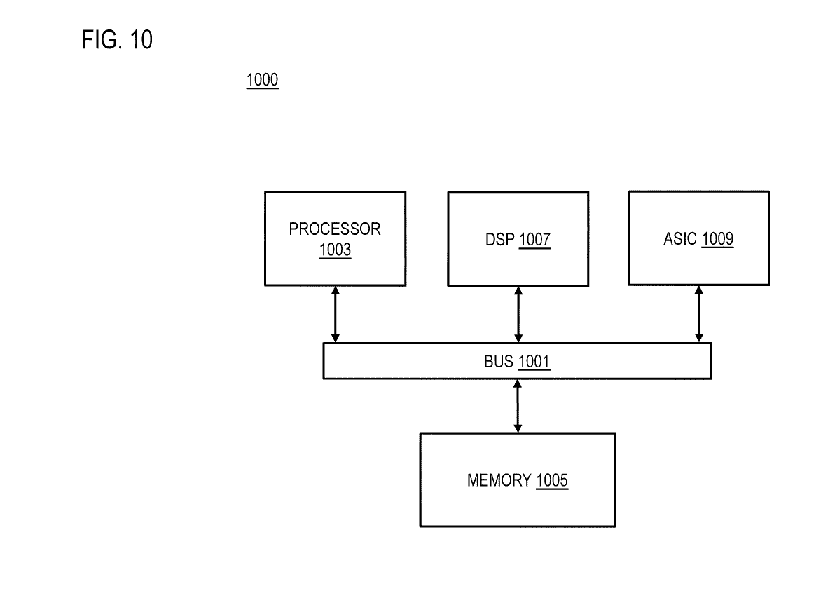

FIGS. 4 through 6 illustrate flowcharts of various processes for, at least, authorizing various access and utilization options at a vehicle via certificates, according to various embodiments. In various embodiments, a VI client 123 and/or a UE 101 may perform one or more portions of the processes 400, 500, and 600, which may be implemented in, for instance, a chip set including a processor and a memory as shown in FIG. 10. As such, a VI client 123 and/or a UE 101 can provide means for accomplishing various parts of the process 400, 500, and 600 as well as means for accomplishing other processes in conjunction with other components of the system 100. Throughout these processes, a VI client 123 and/or a UE 101 may be referred to as completing various portions of the processes 400, 500, and 600, however, it is understood that other components of the system 100 can perform some and/or all of the process steps. Further, for clarity in discussing the 400, 500, and 600 processes, a VI client 123 is referred to as completing various steps of said processes.

In step 401 of the FIG. 4, a VI client 123 may process and/or facilitate a processing of one or more configuration parameters for determining one or more rights associated with a vehicle, wherein the rights include, at least in part, one or more access rights, one or more action rights, or a combination thereof. In one embodiment, a VI client 123; for example at a UE 101, at a VC system 109, and the like, may receive input from a user that may include various configuration parameters for defining various options and features at the vehicle. For example, the options and features may include one or more rights for accessing the vehicle and/or perform various actions available at the vehicle. In one instance, the rights may include an authorization for one or more users to access a vehicle, start its engine, move the vehicle, utilize a communication device of the vehicle, and the like. In one embodiment, the rights may include one or more authorization for a service vendor to provide and/or facilitate one or more services on the vehicle. For example, the rights may indicate that a service vendor may wash the vehicle as well as rotate its tires. In one embodiment, the rights may indicate that a service vendor may charge any fees to a user account, wherein the charges may be associated with one or more requested services and/or for utilization of the service vendor facilities.

In step 403, a VI client 123 may cause, at least in part, an association of the one or more rights with at least one certificate. In one embodiment, the VI client 123 may utilize one or more algorithms, applications, software programs, and the like to associate the one or more rights with one or more certificates where the certificates may include authorization codes/keys, authentication codes/keys, security codes, and the like. In various examples, the certificates may include encoded alphanumeric characters, a passphrase, etc. In one example, a parking service vendor may have promised to service a vehicle, but the service may not be able to be completed that the parking facilities as previously planned. Later, the owner of the vehicle may not have data connection with the vehicle; however, the service vendor may call the vehicle owner to request an authorization code or a passphrase to utilize via a network service provider, a dedicated application, at the VC system 109, etc. so that the current set of rights may be amended to provide the rights so that the service vendor may complete the promised service at a different service facility.

In step 405, a VI client 123 may cause, at least in part, a transfer of the at least one certificate to one or more service vendors, one or more users, or a combination thereof. In one embodiment, a VI client 123 may transfer or authorization of a certificate to a user device; for example, a UE 101, etc., where a user and/or a service vendor may utilize the user device for accessing a specific vehicle. In one embodiment, the processing platform 107 and/or a service provider 105 may cause the transfer of a certificate. In one embodiment, a certificate may include one or more rights associated with a plurality of vehicles. In one example, a user may be a temporary user, for instance, a friend, a family member, a service attendant, and the like. In one example, a service vendor may include one or more purveyors of vehicle services, for instance, at a parking garage, at a repair facility, at a marina, at an airport, and the like.

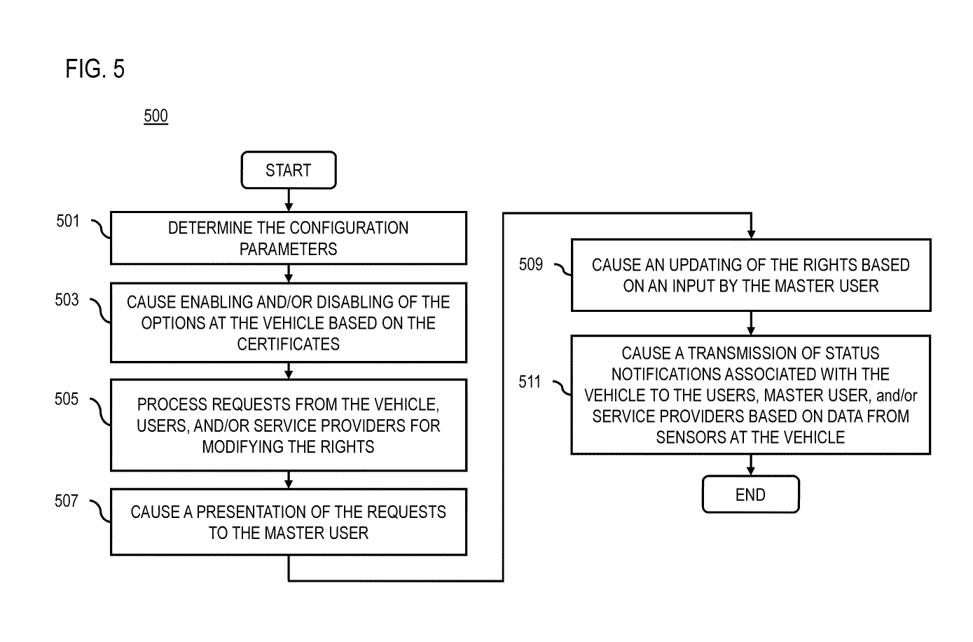

In step 501 of the FIG. 5, a VI client 123 may determine the one or more configuration parameters based, at least in part, on a location of the vehicle, a duration of time, identity of the one or more users, one or more inputs by a master user of the vehicle, or a combination thereof. In various embodiments, a master user (e.g., an owner) may define the configuration parameters to include various elements for defining validity of the rights according to, for example, a location of the vehicle, a time of day, day of week, for a specific duration of time, identity of the user who may utilize the rights, and the like. In one embodiment, the at least one certificate provides access to a physical space at the vehicle, a vehicle movement, one or more options at the vehicle, or a combination thereof. For example, a user may be authorized to access and utilize a vehicle during the hours of 8:00 AM and 2:00 PM, within a particular geo-graphic location, without access right to the in-vehicle mobile phone or glove compartment, while the vehicle may not exceed a speed of 50 miles-per-hour (mph), and the like.

In step 503, a VI client 123 may cause, at least in part, an enabling, a disabling, or a combination thereof of the one or more options at the vehicle based, at least in part, on the at least one certificate. In one embodiment, the VC system 109 may enable or disable one or more options and features at a vehicle. For example, a certificate may be associated with one or more rights that may cause the VC system 109 to disable a feature to raise the top on a convertible vehicle, or disable a sports-mode driving option, or disable one or more functions of an infotainment system in the vehicle, and the like.

In step 505, a VI client 123 may process and/or facilitate a processing of one or more requests from the vehicle, the one or more users, the one or more service vendors, or a combination thereof for modifying the one or more rights. In one embodiment, a temporary user may request to have the rights associated with his certificate modified so that he may be able to utilize one or more options and features differently than what may have been associated with his certificate. For example, the temporary user may need to move the vehicle from its current location to a different location (e.g., to avoid damage due to a nearby fire) or may wish to move it outside of the geo-location boundary (e.g., a teenager wishes to drive to a friend's house outside of a predefined geo-location boundary) associated with his certificate. In various examples, a certificate may include one or more rights to allow for a temporary user to drive the vehicle for a certain duration of time (e.g., two hours from initial use), for a certain total distance (e.g., 20 miles), along a certain route (e.g., from a point A to a point B), and the like.

In step 507, a VI client 123 may cause, at least in part, a presentation of one or more requests to the master user. In one embodiment, the VC system 109 and/or a UE 101 may cause a request message to be sent to a master user of the vehicle who may be at a remote location from the vehicle. In one embodiment, the request may be presented via one or more service vendors associated with the temporary user, with the master user, with a service purveyor facility, and the like.

In step 509, a VI client 123 may cause, at least in part, an updating of the one or more rights based, at least in part, on an input by the master user. In various embodiments, the processing platform 107, a service provider 105, and/or another component in the system 100 may determine an input by the master user for updating the one or more rights according to the master user input. For example, the master user may agree with changing the rights associated with a certificate of an attendant at a parking facility so that the attendant may move the vehicle to a different parking space. In one example, a service vendor may need to move the vehicle to another service vendor facility for additional services.

In step 511, a VI client 123 may cause, at least in part, a transmission of one or more status notifications associated with the vehicle to the one or more users, the master user, the one or more service vendors, or a combination thereof based, at least in part, on data from one or more sensors at the vehicle. In one embodiment, a VC system 109, a VI client 123, and/or one or more other components of the system 100 may cause for status information from one or more sensors of the vehicle to be sent to a master user. For example, a VC system 109 may determine that a tire pressure sensor on the vehicle indicates that the associated tire may need servicing. In one example, a location sensor of a vehicle may indicate that location of the vehicle is changing and may be outside the geo-location boundaries set by the master user.

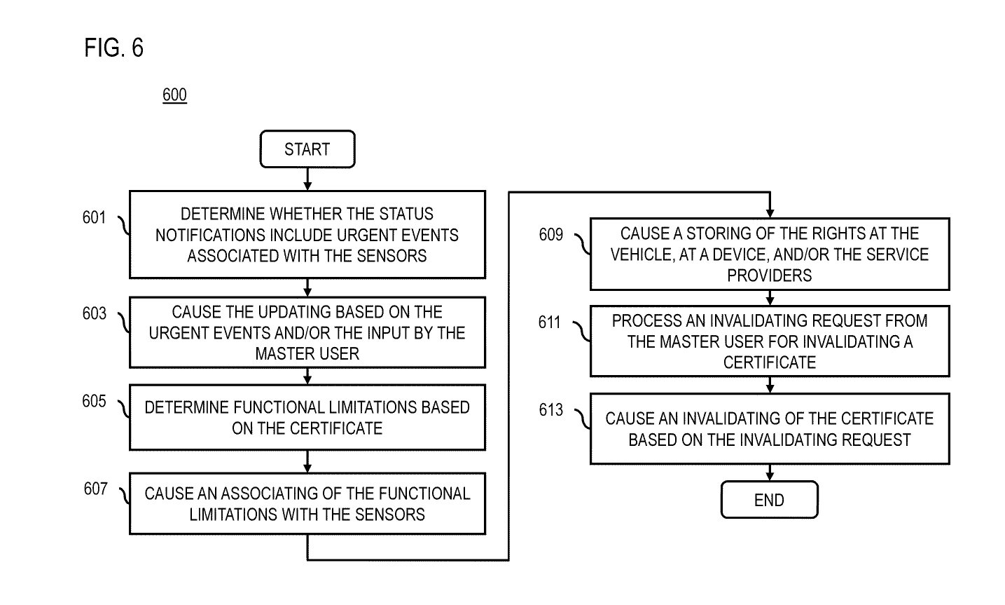

In step 601 of the FIG. 6, a VI client 123 may determine whether the one or more status notifications include one or more urgent events associated with the one or more sensors. In various embodiments, various sensors of a vehicle may detect an event (e.g., a potential emergency) at or near the vehicle, which may need urgent attendance by a person or a service vendor. For example, a heat sensor on the vehicle may detect heat from the surrounding area, which can indicate that a nearby vehicle or structure may be malfunctioning, may be on fire, and the like.

In step 603, a VI client 123 may cause, at least in part, the updating based at least in part, on the one or more urgent events, the input by the master user, or a combination thereof. In one embodiment, the master user may cause the processing platform 107 and/or a service provider 105 to transfer rights to one or more temporary users and/or service vendors via one or more certificates for addressing the one or more urgent events. In one example, the service provider 105 may receive an input from the master user for updating (e.g., approving) one or more rights for a service vendor to disconnect a malfunctioning alarm on the vehicle.

In step 605, a VI client 123 may determine one or more functional limitations based, at least in part, on the at least one certificate. In one example, a certificate may be configured to indicate one or more functional limitations at a vehicle. For example, a certificate may not allow a user to open various compartments at a vehicle. In one example, a temporary user may not able to utilize the certificate more than a certain number of uses. In one example, the temporary user may not be able to open the trunk or rear doors of a vehicle. In one instance, a certificate may not include rights for a temporary user to use all features of an in-vehicle infotainment system, for example, to buy/rent content (e.g., music, navigation maps, concierge services, etc.) using the vehicle owner's credentials previously saved in the in-vehicle infotainment system. In one example, a certificate may not allow a temporary user to modify settings of an in-vehicle infotainment system, e.g., change preset radio channels, add new radio channels, and the like. In one embodiment, a certificate may cause a VC system 109 to request that a temporary user would have to provide a breath sample (e.g., blow in to an alcohol analyzer) to activate one or more rights associated with the certificate and the vehicle. In one example, a temporary user may only drive the vehicle between the hours of 8:00 AM and 8:00 PM, but on Friday nights the temporary use may have to provide the breath sample before the certificate enable any rights to use the vehicle.

In step 607, a VI client 123 may cause, at least in part, an associating the one or more functional limitations with the one or more sensors. In various examples, a certificate may cause one or more sensors of a vehicle to function under certain limitations, for instance, a camera and a microphone of an entertainment system may be disabled. In one example, an accelerator at the vehicle may be allowed to only function to a certain preset level.

In step 609, a VI client 123 may cause, at least in part, a storing of the one or more rights at the vehicle, at one or more devices, at the one or more service vendors, or a combination thereof. In various embodiments, various data associated with the rights and various users, devices, keys, and the like may be associated with and/or stored at one or more UEs 101, the certificates 127, a service provider database 117, a local storage 121 at the vehicle, and the like. In various embodiments, a master user, a VC system 109, a service provider 105, and the like may access the stored information for future use associated with the vehicle, one or more rights, one or more temporary users, and the like.

In step 611, a VI client 123 may process and/or facilitate a processing of at least one invalidating request from the master user for invalidating the at least one certificate. In one example, a master user may wish to cancel one or more portions of one or more rights associated with one or more certificates, which may be associated with a vehicle, one or more temporary users, and the like. For example, a master user (e.g., an owner) may wish to cancel the rights associated with a certificate and a temporary user so that the one or more rights may be assigned to one or more other temporary users. In one example, a master user may have a scheduling conflict associated with one or more certificates already assigned to one or more temporary users.

In step 613, a VI client 123 may cause, at least in part, an invalidating of the at least one certificate based, at least in part, on the at least one invalidating request. In one example, the processing platform 107, the service provider 105, and/or a UE 101 may cause invalidating of the one or more certificates, for instance, by transmitting one or more commands/messages to the VC system 109.

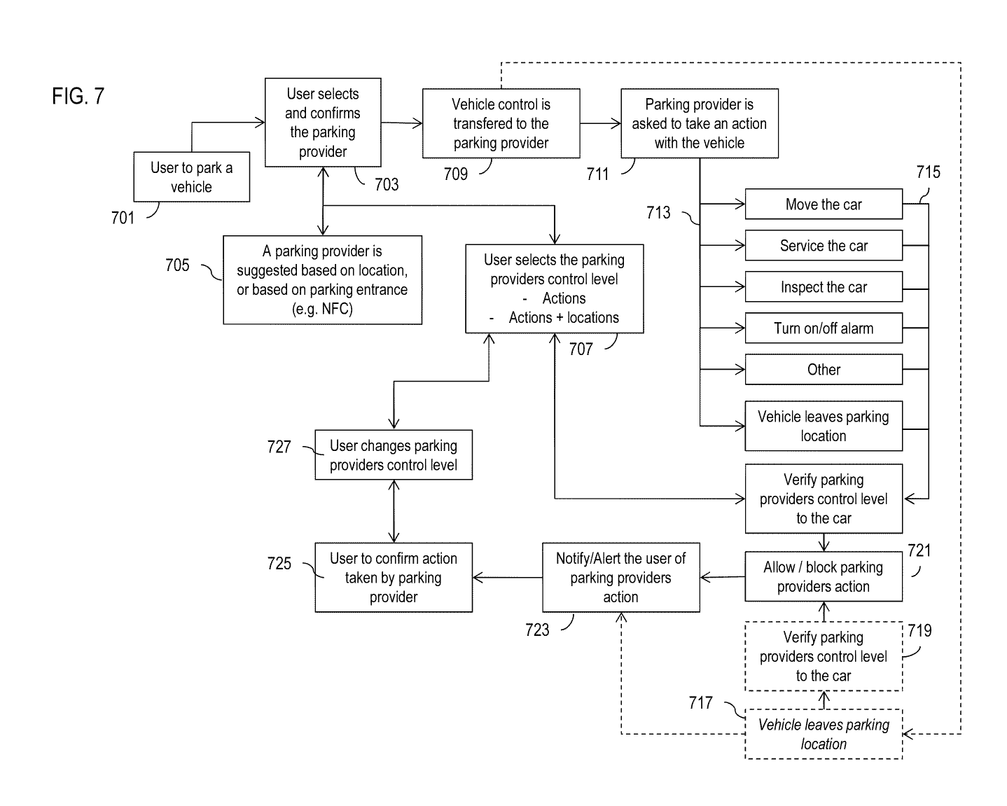

FIG. 7 illustrates an example use case scenario flow chart, according to various embodiments. In one embodiment, at 701a user wishes to park his vehicle at a parking facility where he selects a parking provider at 703. I one example, at 705 a service provider 105 may recommend to the user a parking provider based on location, available services, cost, and the like. At 707, the user may select a parking provider and determine one or more actions and options, rights and the like to associate with the parking provider. Alternatively, at 703, the user may transfer control of the vehicle to the parking provider at 709. In one scenario, the user may transfer the various rights and actions to the parking provider via one or more certificates by transferring the certificates to one or more devices associated with the parking provider, for example, a dedicated console, an RFID tag station, and the like. In one example, at 711, the user may include one or more requests in the certificates for the parking provider to perform certain actions/services while the vehicle is under the parking provider's control. For example, the parking provider may preform one or more tasks of options 713, for instance, to move the vehicle to a different location, service the vehicle, and the like. In one embodiment, at 715, the VC system 109 may check the certificates to determine if the parking provider has the required rights to perform the tasks. In one embodiment, after the vehicle control is transferred to the parking provider at 709, if at 717 the parking provider attempts to move the vehicle from the parking location/facility, then at 719 the VC system 109 may check to verify if the parking provider has the required right to move the vehicle and at 721 moving of the vehicle may be allowed or blocked by the VC system 109. In either case, at 723 the user may be notified of the attempt to move the vehicle. At 725 the user may confirm to allow the actions (e.g., move the vehicle) by the parking provider and/or may change the parking provider's rights at 727.

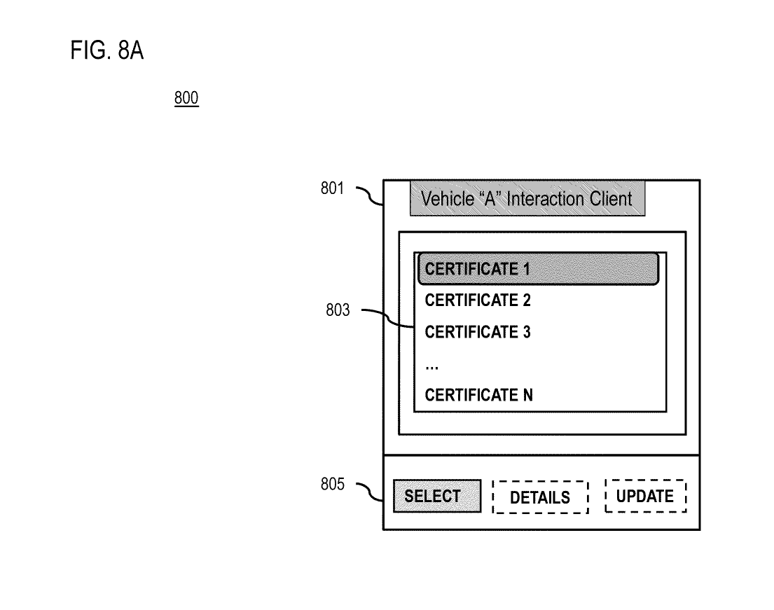

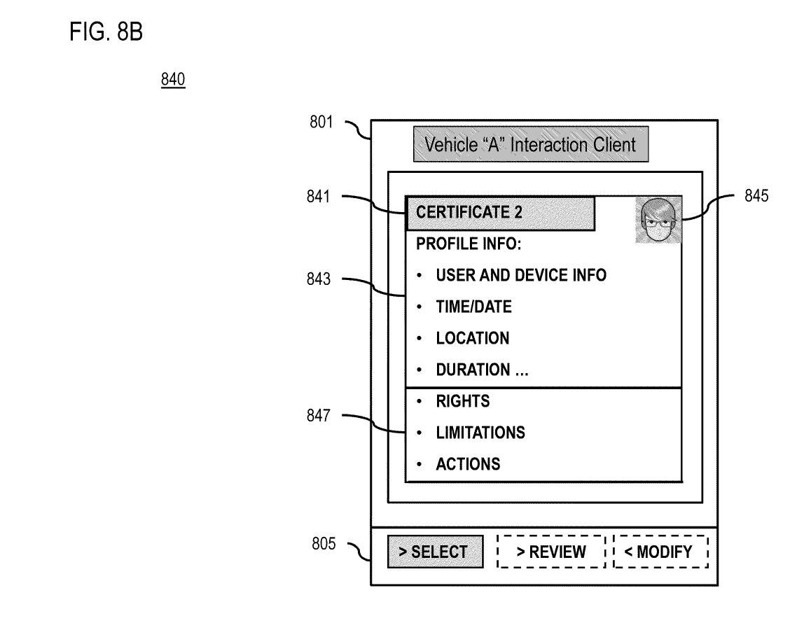

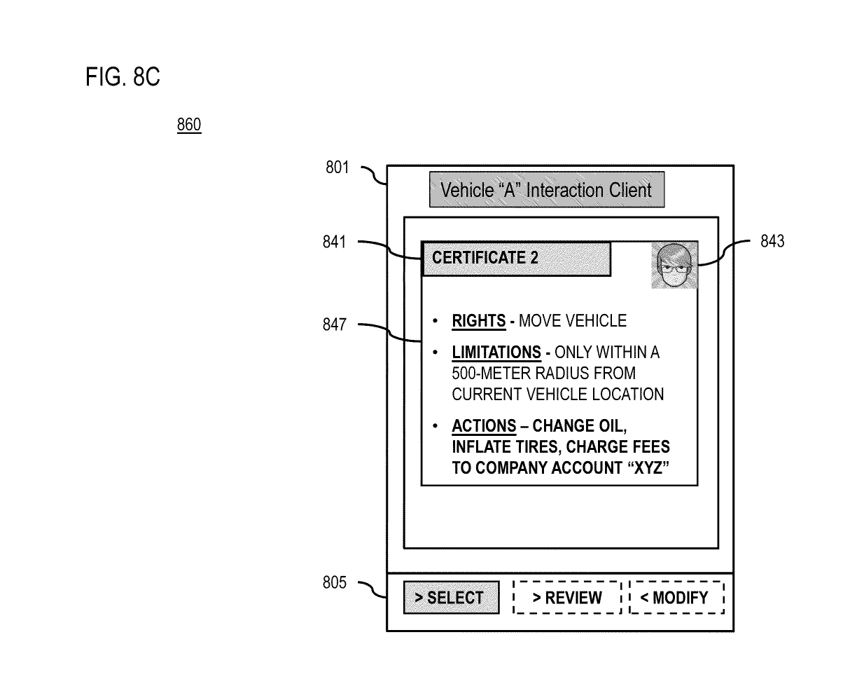

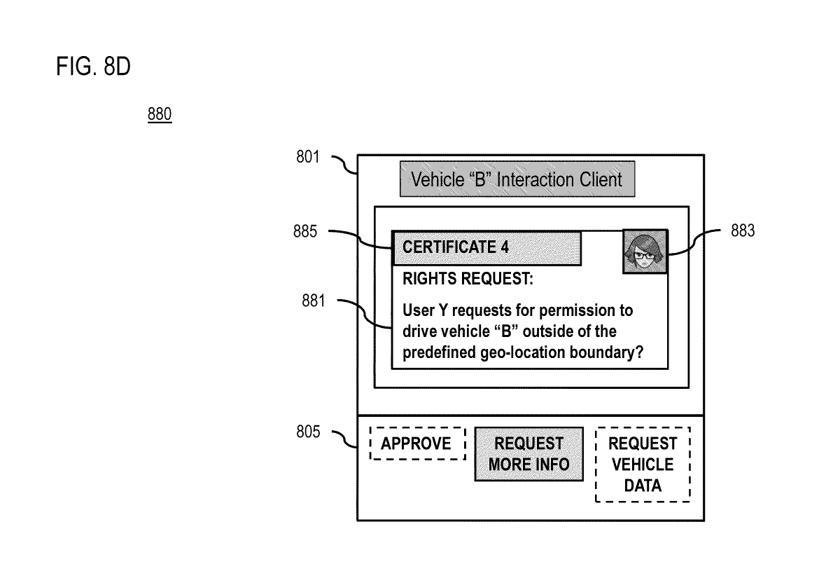

FIGS. 8A through 8D illustrate various user interface diagrams for interfacing with a vehicle interaction client, according to various embodiments.

FIG. 8A depicts diagram 800 of a UI 801 at a VI client associated with a vehicle “A.” In various embodiments, the VI client may be accessed at a vehicle, at a UE 101, at a service vendor, and the like. In one example, a master user may generate new and/or review existing certificates 803 for various actions via options 805, for example, to select for viewing details, updating, and the like.

FIG. 8B includes diagram 840 which shows UI 801 where a user has selected certificate 2 at 841 for viewing details 843. In one embodiment, the certificate 2 may be associated with an image of a user 845. In various embodiments, the details 843 may include profile information including user 845 and associated device information (e.g., a UE 101), time/date, location, duration, etc. that may be associated with the certificate 2. Further, rights, limitations, actions, etc. may be listed in 847 where the user may select any item for further interaction via options 805, for example, to select, review, modify, and the like.

In FIG. 8C, diagram 860 shows the UI 801 where in 847 a user may review details associated with the rights, limitations, actions, and the like. For example, the rights may indicate that a user may move the vehicle with the limitations indicating a 500-meter radius from the current vehicle location. Further, the actions may indicate as to what actions a temporary user or a service vendor may perform on the vehicle, for example, change the engine oil, inflate tires to appropriate pressures, and charge the associated fees to one or more accounts.

FIG. 8D includes diagram 880 showing the UI 801 which is associated with a VI client for a vehicle “B.” In one example, a rights request/message 881 from a user 883, which is associated with a certificate 4 (885), is presented to a master user, where the master user may have various options in 805 for responding to the request. For example, the user 883 may request for additional/modification of rights associated with the certificate 4 so that the user 883 may be able to move the vehicle “B” outside of a predefined geo-location boundary associated with the certificate 4. In one example, the master user may select in 805 to approve, or request more information from the user 883, or request vehicle “B” data (e.g., does it have enough gas/charge, current location, etc.), and the like.

The processes described herein for authorizing various access and utilization options at a vehicle via certificates may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

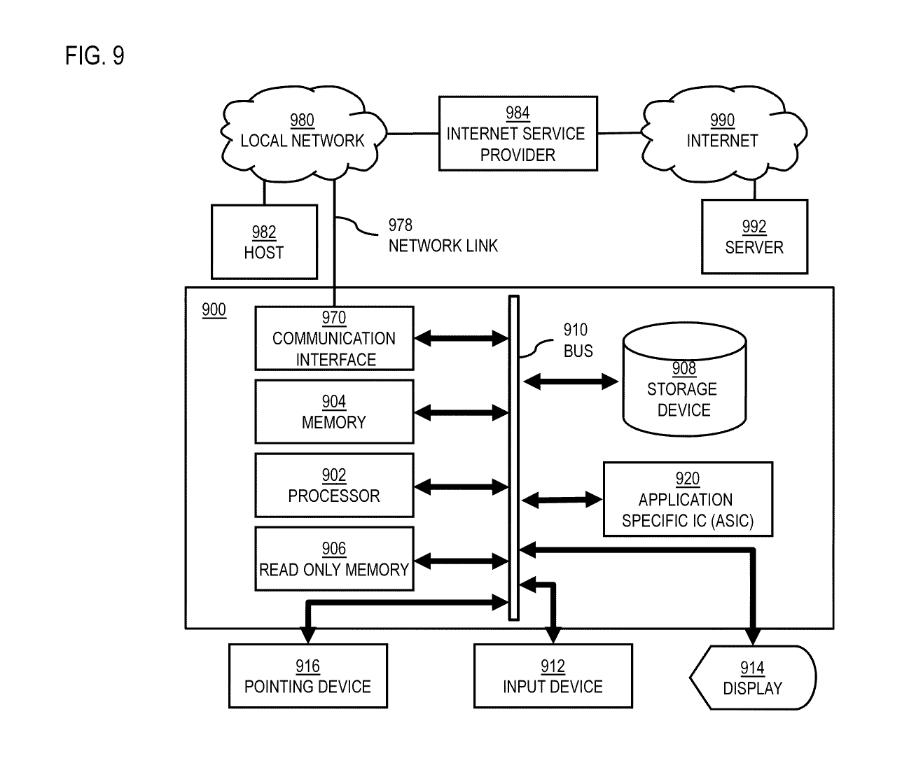

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to authorize various access and utilization options at a vehicle via certificates as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic, and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of authorizing various access and utilization options at a vehicle via certificates.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to authorizing various access and utilization options at a vehicle via certificates. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for authorizing various access and utilization options at a vehicle via certificates. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for authorizing various access and utilization options at a vehicle via certificates, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, which carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 113 for authorizing various access and utilization options at a vehicle via certificates.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to authorize various access and utilization options at a vehicle via certificates as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of authorizing various access and utilization options at a vehicle via certificates.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to authorizing various access and utilization options at a vehicle via certificates. The memory 1005 also stores the data associated with or generated by the execution of the inventive steps.

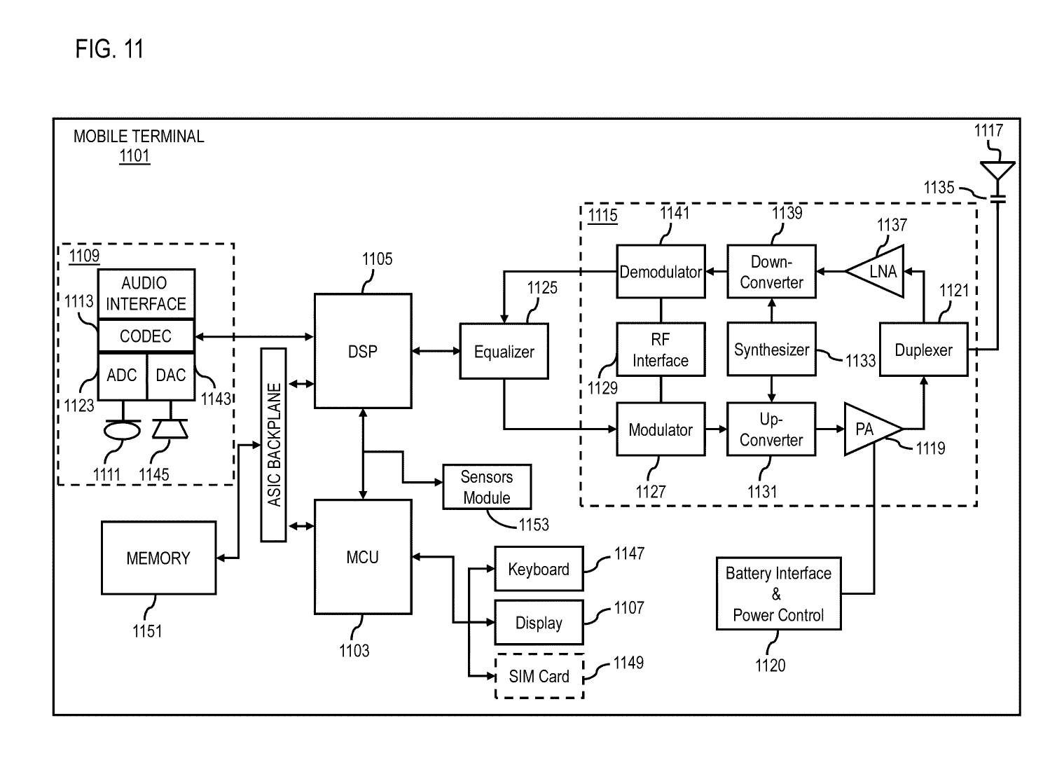

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of authorizing various access and utilization options at a vehicle via certificates. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of authorizing various access and utilization options at a vehicle via certificates. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairment that may occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to authorize various access and utilization options at a vehicle via certificates. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Additionally, sensors module 1153 may include various sensors, for instance, a location sensor, a speed sensor, an audio sensor, an image sensor, a brightness sensor, a biometrics sensor, various physiological sensors, a directional sensor, and the like, for capturing various data associated with the mobile terminal 1101 (e.g., a mobile phone), a user of the mobile terminal 1101, an environment of the mobile terminal 1101 and/or the user, or a combination thereof, wherein the data may be collected, processed, stored, and/or shared with one or more components and/or modules of the mobile terminal 1101 and/or with one or more entities external to the mobile terminal 1101.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a processing of one or more configuration parameters for determining one or more rights associated with a vehicle, wherein the rights include, at least in part, one or more access rights, one or more action rights, or a combination thereof;
an association of the one or more rights with at least one certificate; and
a transfer of the at least one certificate to one or more service vendors, one or more users, or a combination thereof.

2. A method of claim 1, wherein the (1) data and/or (2) information and/or (3) at least one signal are further based, at least in part, on the following:
at least one determination of the one or more configuration parameters based, at least in part, on a location of the vehicle, a duration of time, identity of the one or more users, one or more inputs by a master user of the vehicle, or a combination thereof.

3. A method of claim 2, wherein the at least one certificate provides access to a physical space at the vehicle, a vehicle movement, one or more options at the vehicle, or a combination thereof.

4. A method of claim 3, wherein the (1) data and/or (2) information and/or (3) at least one signal are further based, at least in part, on the following:
an enabling, a disabling, or a combination thereof of the one or more options at the vehicle based, at least in part, on the at least one certificate.

5. A method of claim 2, wherein the (1) data and/or (2) information and/or (3) at least one signal are further based, at least in part, on the following:
a processing of one or more requests from the vehicle, the one or more users, the one or more service vendors, or a combination thereof for modifying the one or more rights;
a presentation of the one or more requests to the master user; and
an updating of the one or more rights based, at least in part, on an input by the master user.

6. A method of claim 2, wherein the (1) data and/or (2) information and/or (3) at least one signal are further based, at least in part, on the following:
a transmission of one or more status notifications associated with the vehicle to the one or more users, the master user, the one or more service vendors, or a combination thereof based, at least in part, on data from one or more sensors at the vehicle.

7. A method of claim 6, wherein the (1) data and/or (2) information and/or (3) at least one signal are further based, at least in part, on the following:
at least one determination of whether the one or more status notifications include one or more urgent events associated with the one or more sensors; and
the updating based at least in part, on the one or more urgent events, the input by the master user, or a combination thereof.

8. A method of claim 6, wherein the (1) data and/or (2) information and/or (3) at least one signal are further based, at least in part, on the following:
determining one or more functional limitations based, at least in part, on the at least one certificate; and
causing, at least in part, an associating the one or more functional limitations with the one or more sensors.

9. A method of claim 1, wherein the (1) data and/or (2) information and/or (3) at least one signal are further based, at least in part, on the following:
a storing of the one or more rights at the vehicle, at one or more devices, at the one or more service vendors, or a combination thereof.

10. A method of claim 1, wherein the (1) data and/or (2) information and/or (3) at least one signal are further based, at least in part, on the following:
a processing of at least one invalidating request from the master user for invalidating the at least one certificate; and
an invalidating of the at least one certificate based, at least in part, on the at least one invalidating request.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of one or more configuration parameters for determining one or more rights associated with a vehicle,
wherein the rights include, at least in part, one or more access rights, one or more action rights, or a combination thereof;
cause, at least in part, an association of the one or more rights with at least one certificate; and
cause, at least in part, a transfer of the at least one certificate to one or more service vendors, one or more users, or a combination thereof.

12. An apparatus of claim 11, wherein the apparatus is further caused to:
determine the one or more configuration parameters based, at least in part, on a location of the vehicle, a duration of time, identity of the one or more users, one or more inputs by a master user of the vehicle, or a combination thereof.

13. An apparatus of claim 12, wherein the at least one certificate provides access to a physical space at the vehicle, a vehicle movement, one or more options at the vehicle, or a combination thereof.

14. An apparatus of claim 13, wherein the apparatus is further caused to:
cause, at least in part, an enabling, a disabling, or a combination thereof of the one or more options at the vehicle based, at least in part, on the at least one certificate.

15. An apparatus of claim 12, wherein the apparatus is further caused to:
process and/or facilitate a processing of one or more requests from the vehicle, the one or more users, the one or more service vendors, or a combination thereof for modifying the one or more rights;
cause, at least in part, a presentation of the one or more requests to the master user; and
cause, at least in part, an updating of the one or more rights based, at least in part, on an input by the master user.

16. An apparatus of claim 12, wherein the apparatus is further caused to:
cause, at least in part, a transmission of one or more status notifications associated with the vehicle to the one or more users, the master user, the one or more service vendors, or a combination thereof based, at least in part, on data from one or more sensors at the vehicle.

17. An apparatus of claim 16, wherein the apparatus is further caused to:
determine whether the one or more status notifications include one or more urgent events associated with the one or more sensors; and
cause, at least in part, the updating based at least in part, on the one or more urgent events, the input by the master user, or a combination thereof.

18. An apparatus of claim 16, wherein the apparatus is further caused to:
determine one or more functional limitations based, at least in part, on the at least one certificate; and
cause, at least in part, an associating the one or more functional limitations with the one or more sensors.

19. An apparatus of claim 11, wherein the apparatus is further caused to:
cause, at least in part, a storing of the one or more rights at the vehicle, at one or more devices, at the one or more service vendors, or a combination thereof.

20. An apparatus of claim 11, wherein the apparatus is further caused to:
process and/or facilitate a processing of at least one invalidating request from the master user for invalidating the at least one certificate; and
cause, at least in part, an invalidating of the at least one certificate based, at least in part, on the at least one invalidating request.

21.-48. (canceled)
